(19) United States
(12) Patent Application Publication
(10) Pub. No.: US 2009/0208663 A1
(43) Pub. Date: Aug. 20, 2009

(54) SPRAY WOOD COATING SYSTEM HAVING IMPROVED HOLDOUT

(75) Inventors: Bradley J. Winkle, Greensboro, NC (US); Lloyd E. Tucker, Kernersville, NC (US); John F. Grunewalder, Greensboro, NC (US)

Correspondence Address: IPLM GROUP, P.A., POST OFFICE BOX 18455, MINNEAPOLIS, MN, 55418, US

(73) Assignee: Valspar Sourcing, Inc.

(21) Appl. No.: 12/431,566

(22) Filed: Apr. 28, 2009

Related U.S. Application Data
(63) Continuation-in-part of application No. PCT/US2008/057235, filed on Mar. 17, 2008.
(60) Provisional application No. 60/895,381, filed on Mar. 16, 2007.

(51) Int. Cl. B05D 3/02; C08K 3/36

(52) U.S. Cl. 427/512; 427/387; 524/493

(57) ABSTRACT

A wood substrate is coated by spray-applying onto the substrate a 100% solids transparent coating composition containing sufficient silica-containing semithixotropic particulate having an average particle size of about 1 to about 20 micrometers to provide improved coating holdout, and curing the thus-applied coating. The coating may be applied at lower wet coating weights (thinner wet coating thicknesses) than a coating that does not employ silica-containing semithixotropic particulate. On variable grain density wood substrates such as cherry, the coating exhibits less localized soak in (better holdout) and provides a cured finish with a more uniform appearance over high and low grain density regions.

This application is a continuation-in part of International patent application PCT/US20008/57235 which claims priority from U.S. provisional patent application Ser. No. 60/895,381, filed Mar. 16, 2007, the disclosures of which are incorporated herein by reference.

### TECHNICAL FIELD

This invention relates to coating compositions and methods for applying coating compositions to wood products.

### BACKGROUND

100% solids coating compositions (e.g., UV-curable coating compositions) can provide desirable reductions in hazardous airborne pollutants. If formulated using suitable ingredients, e.g., low viscosity monomers or oligomers, these compositions may also be spray-applied. However, when spray-applied onto a porous substrate, some of the applied composition may soak into the substrate before the composition can be cured. Such soak-in may prevent the formation of a continuous cured film over the coated substrate unless the composition is applied at a significantly increased coating weight.

Consumers are especially sensitive to the appearance of coated wood surfaces. The consumer generally desires a smooth coated finish through which the underlying wood grain may be clearly seen (and in some instances felt) but which is not so thick so as to have an artificial, “plastic” appearance. The finish must, however, not be so thin so as to provide a discontinuous coating. Thus, extra care and skill are usually required when applying transparent coatings on wood substrates.

It can be especially difficult for a cabinetry or furniture manufacturer to spray-apply a satisfactory 100% solids transparent or semi-transparent coating composition onto woods having variable grain density. Grain density variations may arise, for example, due to year-to-year variations in growing season length or rainfall. Surface regions within a single board or veneer layer, or surface regions of nearby boards or veneer pieces, may accordingly exhibit significant localized differences in grain density, porosity and penetration by an uncured coating composition. Woods such as cherry, alder and poplar are especially prone to such variation. Compensatory application of an increased coating weight may cause formation of overly thick (and consequently objectionable) portions of the cured coating atop less-absorbent regions of the coated wood surface. These thicker regions may be all the more prominent due to their appearance near other thinner regions in which the applied coating composition has more readily penetrated into the wood grain. Localized sanding may be employed to smooth the thicker regions prior to the application of a second coating layer to provide a more uniform overall finish. However, excessive localized sanding can be tedious and may lead to accidental sand-through at the thinner coated areas.

Fumed silica has been added to 100% solids sprayable transparent wood coating compositions to reduce finish penetration and improve coating “hold-out”. However, doing so in amounts sufficient to provide appreciable hold-out improvement also increases the composition viscosity sufficiently so as to make spray application impractical.

### SUMMARY

A method for spray-applying substantially 100% solids transparent coating compositions onto wood substrates at commercially acceptable coating thicknesses and with improved coating hold-out is disclosed. A silica-containing mildly thixotropic (referred to herein as “semithixotropic”) particulate having a greater than submicron average particle size, is added to the coating composition in an amount sufficient to provide improved holdout without unduly compromising the composition's sprayability. The resulting composition may be applied at lower applied wet coating weights (e.g., at thinner applied wet coating thicknesses) compared to a similar coating, but without the particulate, while still providing a continuous coating. On variable grain density wood substrates, the resulting coating exhibits less localized soak in (e.g., better hold-out) and provides a cured finish with a more even overall appearance. In a multilayer coating system, the disclosed method can reduce the amount of sanding that may be required between coats. The present invention thus provides, in one aspect, a method for coating a wood substrate, which method comprises spray-applying onto the substrate a substantially 100% solids coating composition, e.g., transparent, semi-transparent or opaque coatings, comprising sufficient silica-containing semithixotropic particulate having an average particle size of about 1 to about 20 micrometers to provide improved coating hold-out, and curing the thus-applied coating.

The present invention also provides, in another aspect, a composition for coating a wood substrate, which composition comprises a 100% solids coating composition, e.g., transparent, semi-transparent or opaque coatings, comprising sufficient silica-containing semithixotropic particulate having an average particle size of about 1 to about 20 micrometers wherein the coating composition can provide improved coating hold-out.

These and other aspects of the invention will be apparent from the detailed description below. In no event, however, should the above summaries be construed as limitations on the claimed subject matter, which subject matter is defined solely by the attached claims, as may be amended during prosecution.

### DETAILED DESCRIPTION

The recitation of a numerical range using endpoints includes all numbers subsumed within that range (e.g., 1 to 5 includes 1, 1.5, 2, 2.75, 3, 3.80, 4, 5, etc.).

The terms “a,” “an,” “the,” “at least one,” and “one or more” are used interchangeably. Thus, for example, a coating composition that contains “an” additive means that the coating composition includes “one or more” additives.

The term “comprises” and variations thereof does not have a limiting meaning where such term appears in the description or claims. Thus, for example, a composition comprising a wax compound means that the composition includes one or more wax compounds.

The term “(meth)acrylic acid” includes either or both of acrylic acid and methacrylic acid, and the term “(meth)acrylate” includes either or both of an acrylate and a methacrylate.

The terms “preferred” and “preferably” refer to embodiments of the invention that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the invention.

A variety of substantially 100% solids coating compositions may be employed in the disclosed method. Representative coating compositions include free-radically curable coating compositions, cationically curable coating compositions, ionically curable and multipart (e.g., two-part) coating compositions. Suitable coating compositions contain one or more reactive monomers, oligomers or polymers, and may be free of or substantially free of volatile solvents or carriers. The lack of such solvents or carriers contributes to the beneficial environmental characteristics of such compositions, but makes it difficult to apply them using spray coating equipment. The compositions may also be free of or substantially free of water, and thus may be more rapidly cured. Suitable compositions may be cured using radiation (e.g., ultraviolet light (UV), visible light or electron beam energy), thermal energy or a combination thereof. Preferred compositions are cured using radiation.

Representative free-radically curable coating compositions include monomers and oligomers having at least one, and for oligomers, preferably at least two sites of ethylenic unsaturation curable through a free radical-induced polymerization mechanism. Exemplary compositions include those described in U.S. Pat. Nos. 4,600,649, 4,902,975, 4,900,763, 4,065,587, 5,126,394, 6,436,159 B1, 6,641,629 B2, 6,844,374 B2, 6,852,768 B2 and 6,956,079 B2, the disclosures of which are incorporated herein by reference. Representative free-radically curable monomers, oligomers or polymers which may be used in the disclosed method include (meth)acrylates, urethane (meth)acrylates, epoxy(meth)acrylates, polyether(meth)acrylates, polyester(meth)acrylates, silicone(meth)acrylates, cellulosic acrylic butyrates, nitrocellulosic polymers, and blended or grafted combinations thereof. The monomer or monomers may, for example, represent about 10 to about 100%, about 15 to about 45%, or about 30 to about 45% by weight of the coating composition. The oligomer or oligomers may, for example, represent 0 to about 90% or about 30 to about 50% by weight of the coating composition. The chosen monomers may for example be selected to alter the spray characteristics of the curable composition, and may include monofunctional or polyfunctional (e.g., di- or trifunctional) monomers such as isobornyl acrylate, phenoxyethyl acrylate, isodecyl acrylate, hexyl acrylate, cyclohexyl acrylate, 2-ethylhexyl acrylate, octyl acrylate, nonyl acrylate, stearyl acrylate, 2-phenoxy acrylate, 2-methoxyethyl acrylate, lactone modified esters of acrylic and methacrylic acid, methyl methacrylate, butyl acrylate, isobutyl acrylate, methacrylamide, allyl acrylate, tetrahydrofuryl acrylate, n-hexyl methacrylate, 2-(2-ethoxyethoxy)ethyl acrylate, n-lauryl acrylate, 2-phenoxyethyl acrylate, glycidyl methacrylate, glycidyl acrylate, acrylated methylolmelamine, 2-(N,N-diethylamino)-ethyl acrylate, neopentyl glycol diacrylate, alkoxylated neopentyl glycol diacrylate, ethylene glycol diacrylate, hexylene glycol diacrylate, diethylene glycol diacrylate, dipropylene glycol diacrylate, tripropylene glycol diacrylate, tetraethylene glycol diacrylate, pentaerythritol di-, tri-, tetra-, or penta-acrylate, trimethylolpropane triacrylate, alkoxylated trimethylol-propane triacrylate containing, for example, about 2 to about 14 ethylene or propylene oxide units, triethylene glycol diacrylate, tetraethylene glycol diacrylate, alkoxylated neopentyl glycol diacrylate containing, for example, about 2 to about 14 ethoxy or propoxy units, polyethylene glycol diacrylate, 1,3-butylene glycol diacrylate, 1,4-butanediol diacrylate, 1,6-hexanediol diacrylate, polyethylene glycol diacrylate, corresponding methacrylates or acrylates of the acrylates and methacrylates listed above, and mixtures of any of the above.

Representative cationically polymerizable compositions include epoxides and vinyl ethers. Exemplary epoxides include monomeric, oligomeric or polymeric organic compounds having an oxirane ring polymerizable by ring opening, e.g., aliphatic, cycloaliphatic or aromatic materials having, on average, at least one polymerizable epoxy group per molecule and preferably two or more epoxy groups per molecule, and number average molecular weights from 58 to about 100,000 or more. For example, the epoxides may include materials having terminal epoxy groups (e.g., diglycidyl ethers of polyoxyalkylene glycols) and materials having skeletal oxirane units (e.g., polybutadiene polyepoxides). Representative epoxides include those containing cyclohexene oxide groups such as the epoxycyclohexanecarboxylates typified by 3,4-epoxycyclohexylmethyl-3,4-epoxycyclohexanecarboxylate, 3,4-epoxy-2-methylcyclohexylmethyl-3,4-epoxy-2-methylcyclohexane carboxylate, and bis(3,4-epoxy-6-methylcyclohexylmethyl) adipate. For a more detailed list of useful cyclohexane oxide epoxides, reference is made to U.S. Pat. No. 3,117,099. Further representative epoxides include glycidyl ether monomers such as the glycidyl ethers of polyhydric phenols obtained by reacting a polyhydric phenol with an excess of chlorohydrin such as epichlorohydrin (e.g., the diglycidyl ether of 2,2-bis-(2,3-epoxypropoxyphenol)propane). For a more detailed list of useful glycidyl ether epoxides, reference is made to U.S. Pat. No. 3,018,262 and to Lee and Neville, Handbook of Epoxy Resins, McGraw-Hill, New York (1982). Other representative epoxides include octadecylene oxide, epichlorohydrin, styrene oxide, vinyl cyclohexene oxide, vinylcyclohexene dioxide, glycidol, diglycidyl ethers of Bisphenol A (e.g., those available under the trade designations EPON™ from Resolution Performance Products), epoxy vinyl ester resins (e.g., those available under the trade designations DERAKANE™ from Dow Chemical Co.), bis(2,3-epoxycyclopentyl)ethers, aliphatic epoxies modified with polypropylene glycol, dipentene dioxides, epoxidized polybutadienes, silicone resins containing epoxy functionality, epoxy silanes (e.g., beta-(3,4-epoxycyclohexyl)ethyltrimethoxy silane and gamma-glycidoxypropyltrimethoxy silane, flame retardant epoxy resins, 1,4-butanediol diglycidyl ethers, polyglycidyl ethers of phenolformaldehyde novolaks, and resorcinol diglycidyl ethers. Other representative cationically-polymerizable materials and cationically/free radically polymerizable materials include those listed in U.S. Patent Application Publication No. US 2006/0029825 A1, the disclosure of which is incorporated herein by reference. Preferred low viscosity oligomers include polyethers, polyesters, alkoxylated polyepoxy acrylates, aliphatic polyepoxy acrylates, or urethane acrylates and mixtures thereof.

Additional exemplary coating compositions include those described in U.S. Pat. Nos. 4,555,545 and 6,887,937 B1, the disclosures of which are incorporated herein by reference. Other coating compositions that may be employed will be familiar to those skilled in the art.

The disclosed coating compositions optionally may contain an I.R., U.V., or visible-light activated photoinitiator to facilitate curing. Radiation curable compositions that do not contain photoinitiators may be cured using electron beam radiation. Exemplary photoinitiators for free-radically curable compositions include benzophenone, benzoin, acetophenone, benzoin methyl ether, Michler's ketone, benzoin butyl ether, xanthone, thioxanthone, propiophenone, fluorenone, carbozole, diethyoxyacetophenone, 1-hydroxy-cyclohexyl phenyl ketone, the 2-, 3- and 4-methylacetophenones and methoxyacetophenones, the 2- and 3-chloroxanthones and chlorothioxanthones, 2-acetyl-4-methylphenyl acetate, 2,2′-dimethyoxy-2-phenylacetophenone, benzaldehyde, fluorene, anthraquinone, triphenylamine, 3- and 4-allyl-phenone, p-diacetylbenzene, 3-chloro-2-nonylxanthone, 2-chlorobenzophenone, 4-methoxybenzophenone, 2,2′,4,4′-tetrachlorobenzophenone, 2-chloro-4′-methylbenzophenone, 4-chloro-4′-methylbenzophenone, 3-methylbenzophenone, 4-tert-butyl-benzophenone, isobutyl ether, benzoic acetate, benzil, benzilic acid, amino benzoate, methylene blue, 2,2-diethoxyacetophenone, 9,10-phenanthrenequinone, 2-methyl anthraquinone, 2-ethyl anthraquinone, 1-tert-butyl-anthraquinone, 1,4-naphthoquinone, isopropylthioxanthone, 2-chlorothioxanthone, 2-iso-propylthioxanthone, 2-methylthioxanthone, 2-decylthioxanthone, 2-dodecyl-thioxanthone, 2-methyl-1-[4-(methyl thio)phenyl)]-2-morpholinopropanone-1, α,β-diketones (e.g., camphorquinone), combinations thereof and the like. Exemplary photoinitiators for cationically polymerizable compositions include arylsulfonium salts such as those described in U.S. Pat. Nos. 4,161,478 (Crivello et al.) and 4,173,476 (Smith et al.), and ferrocenium salts such as IRGACURE™ 261, commercially available from Ciba Specialty Chemicals. Exemplary photoinitiators for radiation, e.g., UV, curing polymerizable of pigmented compositions include IRGACURE 819, IRGACURE 907, IRGACURE 369, IRGACURE 1800, IRGACURE 1850, or TPO (diphenyl(2,4,6-trimethylbenzoyl)-phosphine oxide), and the like. The photoinitiator or combination of photoinitiators typically will be present in amounts from about 0.5 to about 15%, about 1 to about 9%, or about 1 to about 5% by weight of the coating composition.

A variety of silica-containing semithixotropic particulates may be used in the disclosed method. The silica-containing semithixotropic particulate has an average particle size of about 1 to about 20 micrometers, and may, for example, have an average particle size of about 1 to about 10 or about 1 to about 5 micrometers. The silica-containing semithixotropic particulate imparts mild thixotropy to the coating composition without rendering the composition unsprayable in conventional commercial spray coating equipment. Preferred silica-containing semithixotropic particulates include precipitated silicas and sodium aluminum silicates, such as the PERKASIL™ SM series and ELFADENT™ series of precipitated silicas and SYLOWHITE™ SM 405 and DURAFILL™ 200 sodium aluminum silicates from W. R. Grace, the PERFORM-O-SIL™ series of precipitated silicas from Nottingham Co., the Hi-Sil™ series of precipitated silicas from PPG Industries, Inc., RHODOLINE™ 34M and TIXOSIL™ 34K precipitated silicas and RHODOXANE™ 34 and TIXOLEX™ 24 AB sodium aluminum silicates from Rhodia Silica Systems. The amount of silica-containing semithixotropic particulate shall be sufficient to impart the mild thixotropic (hold-out property) to the coating and is typically, for example, about 0.3 to about 5 weight % of the coating composition, based on the total weight of the coating composition. Preferably, the amount of silica-containing semithixotropic particulate may be about from about 0.4 to about 4.5% of the coating composition weight. More preferably, the amount of silica-containing semithixotropic particulate may be about from about 0.5 to about 3.5% of the coating composition weight.

At amounts less than about 0.3% there may be no appreciable improvement in holdout, and at amounts above about 3.5% the holdout improvement may level off. Wax-coated silicas (such as may be used to impart an anti-matting characteristic to the coating composition) and ground silicas (such as may be used to impart abrasion resistance to the coating composition) typically will not impart thixotropy to the coating composition and, thus, if present, would not be counted as part of the silica-containing semithixotropic particulate amount. Fumed silicas and colloidal silicas usually have too small an average particle size and impart so much thixotropy to the composition at even small addition levels so as to render the composition unsprayable, and accordingly they preferably are not included in the disclosed compositions or, if employed, are present in only minor amounts.

The disclosed compositions may include a variety of adjuvants that will be familiar to those skilled in the art, including dyes, extenders, surfactants, defoamers, waxes, solvents (preferably solvents that do not represent hazardous air pollutants), adhesion promoters, slip agents, release agents, optical brighteners, light stabilizers and antioxidants. The types and amounts of such adjuvants will be apparent to those skilled in the art. Those skilled in the art will also appreciate that due to normal differences in application equipment, application conditions, substrates and quality requirements at different end user sites, adjustments will usually be made in the types and amounts of such adjuvants to tailor a coating composition to a particular end user. It may also be noted that some sodium aluminum silicates have been used in paints as TiO₂ extenders. The disclosed transparent compositions preferably do not contain appreciable amounts of opacifying pigments such TiO₂, since the presence of such opacifying pigments could make the cured coating sufficiently non-transmissive to visible light so that the cured coating is not transparent and the underlying wood grain may not be discerned through the cured coating.

Pigments for use with the semi-transparent or opaque compositions of the present invention are known in the art. Exemplary pigments include titanium dioxide white, carbon black, lampblack, black iron oxide, red iron oxide, transparent red oxide, yellow iron oxide, transparent yellow oxide, brown iron oxide (a blend of red and yellow oxide with black), phthalocyanine green, phthalocyanine blue, organic reds (such as naphthol red, quinacridone red and toulidine red), quinacridone magenta, quinacridone violet, DNA orange, or organic yellows (such as monoazo yellow) and mixtures thereof.

The wood surface may be cleaned and prepared for application of the disclosed coating compositions using methods (e.g., sanding) that will be familiar to those skilled in the art. Stains compatible with radiation curing systems may be applied to the bare wood surface if desired. The coating system preferably is applied as a plurality of layers, e.g., as one or more sealer layers followed by one or more topcoat layers, with light sanding, denibbing or both sanding and denibbing optionally being performed after cure of each layer and prior to application of further layers. Each layer preferably is applied in an amount sufficient to provide good wet coat coverage and a continuous cured coating. A variety of spray application devices may be employed, such as the DUBOIS™ UV mist coater from Dubois Equipment Company, Inc.; reciprocating automated spray machines such as the DUALTEK™ automatic spray machine from Giardina Officine Aeromeccaniche S.P.A.; reciprocating spray machines such as those available from Superfici America, Cefla Finishing America and Makor Srl; carousel and other automated spray equipment such as is available from Cattinair Finishing and fixed head spray systems such as those available from Makor Srl. In addition, hand spraying systems, e.g., airless spray guns, air assisted airless spray guns (AA systems), high volume low pressure (HVLP) systems and the like, can be employed. Recommended uncured (wet) film thicknesses are about 0.01 to about 0.08 mm (about 0.5 to about 3 mils), about 0.01 to about 0.06 mm (about 0.5 to about 2.5 mils) or about 0.01 to about 0.04 mm (about 0.5 to about 1.5 mils), with thinner layers providing more economical application and reduced likelihood of thick cured regions that may require extra sanding, but requiring greater care in controlling application conditions so as to avoid formation of a discontinuous cured film. The layers should be exposed to sufficient curing conditions (e.g., sufficient UV energy in the case of a UV curable layer) to obtain thorough cure. Suitable curing conditions may be determined empirically based on the particular spraying equipment and wood species employed, and the surrounding atmosphere, throughput rate and ambient or elevated temperature at the curing site.

The disclosed method may be employed using a variety of wood substrates including solid boards and wood veneers. Exemplary hardwood species include ash, birch, cherry, alder, mahogany, maple, oak, poplar, teak, hickory and walnut. Exemplary softwood species include cedar, fir, pine and redwood. Preferred hardwood species include substrate comprises cherry or oak. The resulting finished wood products can have a wide variety of uses including furniture, kitchen cabinetry, engineered flooring, doors and trim.

The invention is further illustrated in the following non-limiting examples, in which all parts are parts by weight and percentages are weight % unless otherwise indicated.

### Example 1

### Self-Sealing UV Coating

The ingredients shown below in Table 1 may be combined in the listed order to provide a self-sealing coating composition.

TABLE 1

| Ingredient | Parts |
|---|---|
| Trimethylolpropane triacrylate (TMPTA) | 7 |
| Polyester acrylate oligomer (CN2262 from Sartomer) | 16 |
| Precipitated silica semithixotrope (Hi-Sil ™ T-600, | 3.2 |
| from PPG Industries, Inc.) | |
| 2,4,6-trimethyl benzoyl-diphenyl phosphine oxide | 0.8 |
| 1-hydroxycyclohexylphenylketone (IRGACURE ™ 184, | 6 |
| available from Ciba Specialty Chemicals) | |
| Dispersant (DISPERBYK ™-163, from Byk-Chemie GmbH) | 0.9 |
| Nepheline syenite filler | 3.8 |
| Wax-treated silica matting agent | 3.5 |
| Talc | 4 |
| Ethoxy ethoxyethyl acrylate | 5 |
| Tripropylene glycol diacrylate | 49.8 |
| Total: | 100 |

The composition may be applied to cherry kitchen cabinet doors and cured using medium pressure mercury lamps. Two applied wet coats having about a 0.01 to about 0.02 mm (about 0.5 to about 0.8 mils) thickness may exhibit sufficient holdout and resistance to soak-in so that the cured finish would appear approximately as thick as a comparison coating system made without precipitated silica and applied as two wet coats having about 0.03 to about 0.05 mm (about 1 to about 1.5 mils) thickness. The cured coating made using the Table 1 composition would also have visibly better uniformity between areas of greater and lesser grain density than would be the case for the cured coating made without precipitated silica.

### Example 2

### UV Seal Coat

The ingredients shown below in Table 2 may be combined in the listed order to provide a sealing composition.

TABLE 2

| Ingredient | Parts |
|---|---|
| Trimethylolpropane triacrylate (TMPTA) | 8.6 |
| Polyester acrylate oligomer (CN2262 from Sartomer) | 17.1 |
| Diphenyl (2,4,6-trimethylbenzoyl)-phosphine oxide (LUCIRIN | 0.5 |
| TPO) | |
| Dispersant (DISPERBYK ™-163, from Byk-Chemie GmbH) | 0.4 |
| GENOCURE MBF (from Rahn, USA Corp.) | 4.6 |
| Precipitated silica semithixotrope (Hi-Sil ™ T-600, from PPG | 1.7 |
| industries, Inc.) | |
| Resin Modifier (MODAFLOW 9200 from Cytec) | 0.6 |
| 2-Ethoxyethoxy ethyl acrylate (SR-256 from Sartomer) | 6.2 |
| Tripropyleneglycol diacrylate (TPGDA, SR306 from Sartomer) | 60.3 |
| Total: | 100 |

### Example 3

### UV Seal Coat

The ingredients shown below in Table 3 may be combined in the listed order to provide a sealing composition.

TABLE 3

| Ingredient | Parts |
|---|---|
| Trimethylolpropane triacrylate (TMPTA) | 6.5 |
| Polyether acrylated oligomer (GENOMER 3497 from Rahn | 16.0 |
| USA Corp.) | |
| Precipitated silica semithixotrope (Hi-Sil ™ T-600, from PPG | 2.3 |
| industries, Inc.) | |
| Diphenyl (2,4,6-trimethylbenzoyl)-phosphine oxide (LUCIRIN | 0.5 |
| TPO) | |
| Defoamer (BYK-A 500 from Byk-Chemie GmbH) | 0.2 |
| GENOCURE MBF (from Rahn, USA Corp.) | 2.3 |
| 1-hydroxycyclohexylphenylketone (IRGACURE ™ 184, | 2.1 |
| available from Ciba Specialty Chemicals) | |
| Benzophenone | 0.3 |
| Dispersant (DISPERBYK ™-163, from Byk-Chemie GmbH) | 0.9 |
| Matting agent (SYLOID ™ RAD 2105 from W. R. Grace & Co.) | 5.4 |
| Talc | 0.3 |
| Rheological additive (BYK-410 from Byk-Chemie GmbH) | 0.3 |
| N-Vinyl-2-2pyrrolidone (V-PYROL) | 3.0 |
| 2-Ethoxyethoxy ethyl acrylate (SR-256 from Sartomer) | 5.2 |
| Tripropyleneglycol diacrylate (TPGDA, SR306 from Sartomer) | 54.8 |
| Total: | 100 |

### Example 4

### UV Seal Coat

The ingredients shown below in Table 4 may be combined in the listed order to provide a sealing composition.

TABLE 4

| Ingredient | Parts |
|---|---|
| SIPOMER IBOA-HP | 13.4 |
| EBECRYL 3500 | 20.6 |
| Precipitated silica semithixotrope (Hi-Sil ™ T-600, from PPG | 3.6 |
| industries, Inc.) | |
| Diphenyl (2,4,6-trimethylbenzoyl)-phosphine oxide (LUCIRIN | 0.5 |
| TPO) | |
| 1-hydroxycyclohexylphenylketone (IRGACURE ™ 184, | 6.0 |
| available from Ciba Specialty Chemicals) | |
| Dispersant (DISPERBYK ™-163, from Byk-Chemie GmbH) | 0.7 |
| GENOCURE MBF (from Rahn, Inc.) | 0.7 |
| Tripropyleneglycol diacrylate (TPGDA, SR306 from Sartomer) | 54.6 |
| Total: | 100 |

### Example 5

### UV Seal Coat

The ingredients shown below in Table 5 may be combined in the listed order to provide a sealing composition.

TABLE 5

| Ingredient | Parts |
|---|---|
| Trimethylolpropane triacrylate (TMPTA) | 7.7 |
| EBECRYL 3500 (Epoxy Acrylate from Cytec) | 10.8 |
| Trimethylolpropane triacrylate intermediate (TPGDA internal | 7.2 |
| resin intermediate) | |
| CN2262 (polyether acrylate) | 15.2 |
| anti-settling additive (BYK-411 from Byk-Chemie GmbH) | 0.0 |
| Diphenyl (2,4,6-trimethylbenzoyl)-phosphine oxide (LUCIRIN | 2.2 |
| TPO) | |
| DAROCUR 1173 (photoinitiator) | 2.2 |
| silica flattening agent (from DeGussa) | 1.0 |
| MP 315-38 MICROTALC (talc) | 1.0 |
| Precipitated silica semithixotrope (Hi-Sil ™ T-600, from PPG | 0.4 |
| industries, Inc.) | |
| GENOCURE MBF (from Rahn, Inc.: photoinitiator) | 2.6 |
| MODAFLOW 9200 RESIN MODIFIER (acrylic flow modifier) | 0.5 |
| 2-ethoxyethoxy ethyl acrylate (EOEOEA) | 5.5 |
| Tripropyleneglycol diacrylate (TPGDA) | 43.7 |
| Total: | 100 |

### Example 6

### UV Topcoat

The ingredients shown below in Table 6 may be combined in the listed order to provide a topcoat composition.

TABLE 6

| Ingredient | Parts |
|---|---|
| Trimethylolpropane triacrylate (TMPTA) | 7.3 |
| Polyester acrylate oligomer (CN2262 from Sartomer) | 12.4 |
| Diphenyl (2,4,6-trimethylbenzoyl)-phosphine oxide (LUCIRIN | 0.5 |
| TPO) | |
| Benzophenone | 1.3 |
| GENOCURE MBF (from Rahn, Inc.) | 4.6 |
| Dispersant (DISPERBYK ™-163, from Byk-Chemie GmbH) | 0.5 |
| Dow Corning 11 Additive | 0.7 |
| PERENOL ™ E 8 | 0.1 |
| Matting agent (SYLOID ™ RAD 2105 from W. R. Grace & Co.) | 5.6 |
| Precipitated silica semithixotrope (Hi-Sil ™ T-600, from PPG | 2.2 |
| industries, Inc.) | |
| 2-Ethoxyethoxy ethyl acrylate (SR-256 from Sartomer) | 6.9 |
| Tripropyleneglycol diacrylate (TPGDA, SR306 from Sartomer) | 57.9 |
| Total: | 100 |

### Example 7

### UV Topcoat

The ingredients shown below in Table 7 may be combined in the listed order to provide a topcoat composition.

TABLE 7

| Ingredient | Parts |
|---|---|
| Trimethylolpropane triacrylate (TMPTA) | 6.3 |
| Polyether acrylated oligomer (GENOMER 3497 from Rahn | 15.3 |
| USA Corp.) | |
| Precipitated silica semithixotrope (Hi-Sil ™ T-600, from PPG | 2.2 |
| industries, Inc.) | |
| Diphenyl (2,4,6-trimethylbenzoyl)-phosphine oxide (LUCIRIN | 0.5 |
| TPO) | |
| Defoamer (BYK-A 500 from Byk-Chemie GmbH) | 0.2 |
| Dow Corning 11 Additive | 0.2 |
| GENOCURE MBF (from Rahn, Inc.) | 4.5 |
| Benzophenone | 1.1 |
| 1-hydroxycyclohexylphenylketone (IRGACURE ™ 184, | 1.8 |
| available from Ciba Specialty Chemicals) | |
| Dispersant (DISPERBYK ™-163, from Byk-Chemie GmbH) | 0.9 |
| Matting agent (SYLOID ™ RAD 2105 from W. R. Grace & Co.) | 6.4 |
| Rheological additive (BYK-410 from Byk-Chemie GmbH) | 0.2 |
| V-PYROL (N-vinyl-2-pyrrolidone) | 2.9 |
| 2-Ethoxyethoxy ethyl acrylate (SR-256 from Sartomer) | 5.0 |
| Tripropyleneglycol diacrylate (TPGDA, SR306 from Sartomer) | 52.5 |
| Total: | 100 |

### Example 8

### UV Topcoat

The ingredients shown below in Table 8 may be combined in the listed order to provide a topcoat composition.

TABLE 8

| Ingredient | Parts |
|---|---|
| Trimethylolpropane triacrylate (TMPTA) | 7.2 |
| Polyester acrylate oligomer (CN2262 from Sartomer) | 12.0 |
| Precipitated silica semithixotrope (Hi-Sil ™ T-600, from PPG | 2.0 |
| industries, Inc.) | |
| Diphenyl (2,4,6-trimethylbenzoyl)-phosphine oxide (LUCIRIN | 0.6 |
| TPO) | |
| Defoamer (BYK-A 500 from Byk-Chemie GmbH) | 0.2 |
| GENOCURE MBF (from Rahn, Inc.) | 5.2 |
| 1-hydroxycyclohexylphenylketone (IRGACURE ™ 184, | 2.1 |
| available from Ciba Specialty Chemicals) | |
| Dispersant (DISPERBYK ™-163, from Byk-Chemie GmbH) | 1.0 |
| Rheological additive (BYK-410 from Byk-Chemie GmbH) | 0.2 |
| V-PYROL (N-VINYL-2-2PYRROLIDONE) | 3.3 |
| 2-Ethoxyethoxy ethyl acrylate (SR-256 from Sartomer) | 5.8 |
| Tripropyleneglycol diacrylate (TPGDA, SR306 from Sartomer) | 60.5 |
| Total: | 100 |

### Example 9

### Spray UV topcoat

The ingredients shown below in Table 9 may be combined in the listed order to provide a topcoat composition.

TABLE 9

| Ingredient | Parts |
|---|---|
| Trimethylolpropane triacrylate (TMPTA) | 7.0 |
| Polyester acrylate oligomer (CN2262 from Sartomer) | 16.4 |
| Precipitated silica semithixotrope (Hi-Sil ™ T-600, from PPG | 3.3 |
| industries, Inc.) | |
| Diphenyl (2,4,6-trimethylbenzoyl)-phosphine oxide | 0.8 |
| (LUCIRIN TPO) | |
| Benzophenone | 1.3 |
| GENOCURE MBF (from Rahn, Inc.) | 4.4 |
| Dispersant (DISPERBYK ™-163, from Byk-Chemie GmbH) | 0.9 |
| Dow Corning 11 Additive | 0.6 |
| Surface additive (BYK-371 from Byk-Chemie GmbH) | 0.2 |
| Matting agent (SYLOID ™ RAD 2105 from W. R. Grace & Co.) | 8.6 |
| Rheological additive (BYK-410 from Byk-Chemie GmbH) | 0.1 |
| 2-Ethoxyethoxy ethyl acrylate (SR-256 from Sartomer) | 6.1 |
| Tripropyleneglycol diacrylate (TPGDA, SR306 from Sartomer) | 50.3 |
| Total: | 100 |

### Example 10

### UV Sealer

The ingredients shown below in Table 10 may be combined in the listed order to provide a topcoat composition.

TABLE 10

| Ingredient | Parts |
|---|---|
| Trimethylolpropane triacrylate (TMPTA) | 7.3 |
| Polyester acrylate oligomer (CN2262 from Sartomer) | 12.2 |
| Diphenyl (2,4,6-trimethylbenzoyl)-phosphine oxide (LUCIRIN | 0.5 |
| TPO) | |
| Benzophenone | 1.3 |
| GENOCURE MBF (from Rahn, Inc.) | 4.6 |
| Dispersant (DISPERBYK ™-163, from Byk-Chemie GmbH) | 0.5 |
| Dow Corning 11 Additive | 0.7 |
| PERENOL ™ E 8 | 0.1 |
| Matting agent (SYLOID ™ RAD 2105 from W. R. Grace & Co.) | 6.3 |
| Precipitated silica semithixotrope (Hi-Sil ™ T-600, from PPG | 2.2 |
| industries, Inc.) | |
| 2-Ethoxyethoxy ethyl acrylate (SR-256 from Sartomer) | 6.3 |
| Tripropyleneglycol diacrylate (TPGDA, SR306 from Sartomer) | 58.0 |
| Total: | 100.0 |

A substrate, e.g., cherry kitchen cabinet door, can be coated with a sealing composition described in Examples 2, 3, 4 or 5 at a thickness of about 0.01 to about 0.02 mm (about 0.5 to about 0.8 mils) and cured using medium pressure mercury lamps. The seal coated substrate is lightly sanded or denibbed. The sealed substrate is can be coated with a topcoat composition described above in Examples 6, 7, 8, 9 or 10 at a thickness of about 0.01 to about 0.02 mm and cured using medium pressure mercury lamps. The two applied coats, sealing composition and topcoat composition, each having about a 0.01 to about 0.02 mm (about 0.5 to about 0.8 mils) thickness may exhibit sufficient holdout and resistance to soak-in so that the cured finish would appear approximately as thick as a comparison coating system made without precipitated silica and applied as two wet coats having about 0.03 to about 0.05 mm (about 1 to about 1.5 mils) thickness. The cured coating made using the sealing composition from Examples 2, 3, 4 or 5 and topcoat compositions from Examples 6, 7, 8, 9 or 10 would also have visibly better uniformity between areas of greater and lesser grain density than would be the case for the cured coating made without precipitated silica.

All patents, patent applications and literature cited in the specification are hereby incorporated by reference in their entirety. In the case of any inconsistencies, the present disclosure, including any definitions therein will prevail. The invention has been described with reference to various specific and preferred embodiments and techniques. However, it should be understood that many variations and modifications may be made while remaining within the invention. It should be understood that this invention is not limited to the illustrative embodiments set forth above.

We claim:

1. A method for coating a wood substrate, which method comprises spray-applying onto the substrate a 100% solids transparent or semi-transparent coating composition comprising at least about 0.3 weight % of silica-containing semithixotropic particulate based on the of total weight of the coating composition having an average particle size of about 1 to about 20 micrometers to provide improved coating holdout, and curing the thus-applied coating.

2. The method according to claim 1 wherein the semithixotropic particulate comprises precipitated silica.

3. The method according to claim 1 wherein the semithixotropic particulate comprises sodium aluminum silicate.

4. The method according to claim 1 wherein the semithixotropic particulate has an average particle size of about 1 to about 10 micrometers.

5. The method according to claim 1 wherein the semithixotropic particulate has an average particle size of about 1 to about 5 micrometers.

6. The method according to claim 1 wherein the semithixotropic particulate is about 0.4 to about 4.5 weight % based on the total weight of the coating composition.

7. The method according to claim 1 wherein the semithixotropic particulate is about 0.5 to about 3.5 weight % based on the total weight of the coating composition.

8. The method according to claim 1 wherein the coating composition is applied at an uncured film thickness of about 0.01 to about 0.08 mm.

9. The method according to claim 1 wherein the coating composition is applied in two or more layers.

10. The method according to claim 1 wherein the coating composition is free-radically polymerized.

11. The method according to claim 1 wherein the coating composition is cationically polymerized.

12. The method according to claim 1 comprising UV curing the coating composition.

13. The method according to claim 1 wherein the substrate comprises ash, birch, alder, mahogany, maple, oak, poplar, teak, hickory or walnut.

14. The method according to claim 1 wherein the substrate comprises cherry or oak.

15. A composition for coating a wood substrate, comprising a 100% solids transparent or semi-transparent radiation curable coating composition and sufficient silica-containing semithixotropic particulate having an average particle size of about 1 to about 20 micrometers to provide improved coating holdout.

16. The composition according to claim 15 wherein the semithixotropic particulate comprises precipitated silica.

17. The composition according to claim 15 wherein the semithixotropic particulate comprises sodium aluminum silicate.

18. The composition according to claim 15 wherein the semithixotropic particulate has an average particle size of about 1 to about 10 micrometers.

19. The composition according to claim 15 wherein the semithixotropic particulate is about 0.5 to about 5% of the coating composition weight.

20. The composition according to claim 15 wherein the coating composition is free-radically polymerized.
